(19) United States
(12) Patent Application Publication
(10) Pub. No.: US 2014/0014582 A1
(43) Pub. Date: Jan. 16, 2014

(54) FLUID REMINERALIZATION METHOD

(71) Applicants: Miguel Ramon Muro, Sevilla (ES); Estefania Marcos Puertas, Sevilla (ES); Abel Riaza Frutos, Sevilla (ES); Francisco Javier Bernaola Echevarria, Sevilla (ES)

(72) Inventors: Miguel Ramon Muro, Sevilla (ES); Estefania Marcos Puertas, Sevilla (ES); Abel Riaza Frutos, Sevilla (ES); Francisco Javier Bernaola Echevarria, Sevilla (ES)

(21) Appl. No.: 14/000,985

(22) PCT Filed: Feb. 22, 2012
(86) PCT No.: PCT/ES2012/070102

§ 371 Date: Oct. 4, 2013

(30) Foreign Application Priority Data
Feb. 23, 2011 (ES) P201130237

(51) Int. Cl. C02F 1/68

(52) U.S. Cl. CPC C02F 1/68
USPC 210/638; 210/752

(57) ABSTRACT

The present invention relates to a procedure for remineralization of fluids with control over the final turbidity. The said procedure comprises the stages of dosage of the reagents, remineralization and filtration. More specifically, the invention relates to the treatment of water for human consumption, for industrial processes, agricultural use and other applications which require adjustment of parameters such as hardness, alkalinity, pH, Langelier saturation index (LSI), etc.

The present invention relates to a procedure for remineralization of fluids with control over the final turbidity. The said procedure comprises the stages of dosage of the reagents, remineralization and filtration. The present invention belongs to the technical field of treatment of fluids. More specifically, the invention belongs to the technical field of treatment of water for human consumption, for industrial processes, agricultural use and other applications which require adjustment of parameters such as hardness, alkalinity, pH, Langelier Saturation Index (LSI), etc.

### STATE OF THE ART

Due to the growing needs for water in modern society, the task for ensuring a quality of the water, which corresponds to the adequate physicochemical and organoleptic requirements for the different uses and supplies, becomes complex.

Nowadays there are different technologies for obtaining water with different quality. In many cases, the product water must be conditioned in order to comply with the current legislation depending on the final user, i.e. water for human, industrial, agricultural consumption, etc.

The remineralization is a process that is applied usually to make adequate the quality of the product water. It consists in adding to the water certain components, which it does not contain or have been partially or completely eliminated in a previous process, usually Ca²⁺, HCO₃⁻, Mg²⁺, etc. In addition, this procedure must guarantee the control of the pH, the alkalinity and hardness, the LSI, etc. These parameters are crucial for establishing the quality of the product water and prevent it from being foul or corrosive.

To this purpose, different combinations of reagents are used, and some of them are presented hereafter:
Calcium carbonate (CaCO₃) in combination with carbon dioxide (CO₂) or acid (HCl, H₂SO₄, etc.).
Calcium-magnesium carbonate (MgCaCO₃) in combination with carbon dioxide (CO₂) or acid (HCl, H₂SO₄, etc.).
Calcium hydroxide (Ca(OH)₂) in combination with carbon dioxide (CO₂) or acid (HCl, H₂SO₄, etc.).
Others: CaO, MgO, etc.

In the case of calcium and/or magnesium carbonates, they must be available in the form of a bed in a way that the fluid to be remineralized passes through them in ascending or descending mode.

In the case of calcium hydroxide, it must be prepared in the form of a suspension which is known as lime milk. The aforementioned carbonates can be added also micronized forming a suspension. In both cases, the suspension can be fed to a saturator which acts as a decanter, precipitating both the impurities, which are not completely dissolved (Fe₂O₃, Al₂O₃, SiO₂, etc.), and the excess of reagent that is not dissolved as well as other products of the reaction in the suspension, obtaining in this way theoretically saturated solution.

The remineralization systems based on the above-explained techniques have been object to various patents, such as: EP 0520826, U.S. Pat. No. 5,391,302 and U.S. Pat. No. 5,695,646.

One of the main disadvantages of the systems for remineralization, particularly in the case of the calcium hydroxide, is that the theoretically saturated solution is often not completely saturated and, as a consequence, turbidity appears in the product water. Under normal conditions this fact is not a problem, but in certain practical applications more strict turbidity levels are required and then, therefore, the attempt to adjust the turbidity level can condition the process leading to a mismatch with the remaining parameters.

In order to solve this problem, the option of connecting a filtration system at a given point of the process can be used, a combination that has been object to patents such as: ES2259562 and U.S. Pat. No. 4,670,150.

The use of filtration at a given moment of the remineralization process, as it is shown in ES2259562, permits to forego the lime saturator which is normally used in this type of systems. The said patent proposes a microfiltration system in the system for dosage of the lime milk providing a method for continuous dosage of the lime milk and without substances in the suspension which cause excess of turbidity.

However, this type of processes have the problem that in order to apply a filtration on the own lime milk with high content of matter in the suspension, which is not dissolved, involves a high level of contamination of the filtration system and, consequently, the operation and maintenance costs increase due to the increase of the number of the necessary washings, including the reposition of the membranes.

Therefore, it is necessary to find or develop a procedure for remineralization with which the abovementioned problems are avoided.

### DESCRIPTION OF THE INVENTION

The present invention relates to a remineralization procedure which proposes an improvement with respect to the latest state-of-the-art in the case when a filtration is applied after the process of remineralization.

Moreover, in the present invention, with the purpose to reduce the investment and operating costs, as an alternative to the treatment of the entire amount of the fluid to be remineralized, it is possible to treat only a portion of the same remineralizing in excess and once the process of filtration has been completed, reunifying it with the amount that has not been treated, where by dilution it would be adjusted to the remineralization values established initially for the total amount of fluid to be treated.

Therefore, a first aspect of the present invention relates to a procedure for remineralization of fluids which comprises the following steps:
a. Divide the total amount Qₜ of a fluid to be remineralized, into 2 quantities Q₁ and Q₂.
b. Dose reagents to the flow Q₁.
c. Remineralize the flow Q₁ from step b). This step is completed in a chemical reactor providing a hydraulic residence time (THR) which is sufficient to ensure that any of the remineralization reactions known to an expert in this matter can be produced in a quantitative manner.
d. Filter the flow Q₁ from step c).
e. Mix the flow Q₁ from step d) with the flow Q₂ from step a).

According to a preferred embodiment, the fluid to be remineralized is water. The term water is considered a general one, not excluding for example and without any limitation the pretreated water.

According to another preferred embodiment, the flow Q₁ represents between 0% and 100% of Qₜ. Preferably, Q₁ represents between 0% and 50% of Qₜ. Most preferably, Q₁ represents between 0% and 25% of Qₜ.

According to another preferred embodiment, the flow Q2 represents between 100% and 0% of Qₜ. Preferably, Q2 represents between 100% and 50% of Qₜ. Most preferably, Q2 represents between 100% and 75% of Qₜ.

According to another preferred embodiment, the reagents, which are dosed, are selected from the group formed by: CaCO₃, MgCa(CO₃)₂, Ca(OH)₂, CaO or MgO in a combination or not with:
CO₂
an acid.

According to a preferred embodiment, the reagents, which are dosed, are selected from the group formed by CaCO₃, MgCa(CO₃)₂, CaO and Ca(OH)₂ in combination with CO₂, in exact amounts or in excess in order to facilitate the reaction and guarantee its high efficiency.

According to another preferred embodiment, when the Ca(OH)₂ is dosed, it is dosed as lime milk with or without a previous passage through the saturator. In this case, in which the Ca(OH)₂ is dosed as lime milk, it is prepared by means of:
suspension of Ca(OH)₂ in water; or
reaction of CaO with water.

According to another preferred embodiment, when the CaCO₃ or the MgCa(CO₃)₂ is dosed, it is made available in the form of lime milk, preferably granular, percolating well the fluid to be remineralized by it or circulating in ascending mode, or it is added micronized to the fluid to be remineralized, in the form of lime milk, with or without previous passage through the saturator.

In addition, the reagents are dosed in exact amounts as determined by the corresponding equilibrium, or if they are dosed in excess, this is done to facilitate the reaction. When the reagents are added in excess, the portion that had not reacted will remain in suspension and will be recuperated subsequently by means of the washing of the filtration system which could send them to the head of the installation.

The exact quantities to be added to the reagents depend on the initial conditions of the water to be remineralized, the desired conditions of the product water (pH, hardness, alkalinity, etc.) and the equilibrium constants of the species in the medium.

According to a preferred embodiment, the dosage of the reagents is done in line or in mixing chambers, open or closed.

According to another preferred embodiment, the dosage of the CO₂ is done by using one of the following possibilities:
in line;
in a mixing chamber and bubbling reaction;
bubbling in a totally flooded absorber, with or without refill, with the purpose to achieve higher efficiency in capturing the gas; or
an absorption column, partially flooded with a rain spray or with a pulverizer of a spray type and with or without refill.

According to another preferred embodiment, the excess of CO₂, which has not reacted, is recirculated from front to back of the corresponding dosing system, for example, from front to back of the absorption column.

According to another preferred embodiment, after the step of dosage of the reagents, the flow Q₁ is introduced into a remineralization chamber where the remineralization reaction is completed (any of those known to an expert in this field) and which provides a hydraulic residence time (THR) that is sufficient for achieving the maximum possible performance. In a preferred manner, the hydraulic residence time (THR) is less than or equal to 120 minutes; less than or equal to 60 minutes and most preferably less than or equal to 30 minutes.

If the remineralized solution contains, as it was specified above, non-dissolved matter, which could cause turbidity in the end product, in order to solve this problem, this solution is passed through a filtration system.

According to a preferred embodiment, the filtration system is selected among metal filters, cartridge filters, microfiltration, ultrafiltration or any combination thereof.

According to another preferred embodiment, the filtration system is a microfiltration system.

According to another preferred embodiment, the microfiltration system is at pressure.

When a microfiltration system under pressure is used, an additional technological window is opened for increasing the solubility of the reagents, which provides important savings as a result of the reduction of their losses and the higher efficiency of the process.

According to another preferred embodiment, the microfiltration under pressure is performed in a cross-flow or dead-end. In the first case, the flow is tangential to the filtration surface recirculating part of the amount at the front of the filtration system. In the second case, the flow is perpendicular to the filtration surface in a way that 100% of the amount crosses it and thus there is no recirculation.

According to another preferred embodiment, the microfiltration under pressure is performed in a dead-end.

According to a preferred embodiment, in addition, a step f) of periodical backwashing of the filtration system is completed with the purpose to control its contamination. This backwashing is performed with:
water, with or without air and with or without chemicals.
fluid without remineralization, as for example infusion from a system for inverse osmosis, with or without air and with or without chemicals.

When the backwashing is performed with chemicals, it is proceeded from a cleaning tank to the filtration system (direction that is opposite to the filtration mode), where the reagents for this purpose are selected among HCl, H₂SO₄, C₆H₈O₇ (citric acid), C₆H₈O₆ (ascorbic acid), NaOH, NaOCl, etc. Preferably, the reagent is HCl.

According to another preferred embodiment, in addition to the backwashing, a step g) of chemical washing of the filter is performed, which can use:
water with chemical agents with or without air; or
fluid without remineralization with chemical agents, as for example infusion from a system for inverse osmosis, with or without air.

When the chemical washing is performed, it is proceeded from a cleaning tank to the filtration system (direction that is the same as in the filtration mode), where the reagents for this purpose are selected among HCl, H₂SO₄, C₆H₈O₇ (citric acid), C₆H₈O₆ (ascorbic acid), NaOH, NaOCl, etc. Preferably, the reagent is HCl.

The periodicity of all washings and backwashings, their variants and the type and the concentration of the chemicals can vary from one filter to the others according to the recommendations of the manufacturer.

And finally, after the flow Q₁ passes through the filtration system, in la step e) it is mixed with the flow Q₂ without remineralization, and the total flow Qₜ is obtained with much reduced turbidity, in addition to the remaining parameters adjusted to the values that were established initially.

Optionally, a new step h) of fine tuning of the pH is performed by adding acids or bases until the desired pH of the remineralized fluid from step e) is achieved.

According to a preferred embodiment, the pH fine tuning is performed by adding HCl or NaOH to the remineralized fluid from step e).

Optionally, the water from the backwashing in step f) is recirculated to the front of the installation with the purpose to take advantage of the excessive reagents and those that have not reacted (previous separation of the insoluble ones contained in this flow by any means of physical and/or chemical separation).

A second aspect of the present invention relates to the flow Qₜ, which can be obtained by using the above-described procedure.

In the course of the description and in the claims, the word “comprise” and its variants do not exclude other technical characteristics, additives, components or steps. For the experts in this field, other objects, advantages and characteristics of the invention will be derived partially from the description and partially from the practice of the invention. The following examples and drawings are provided as illustration and they are not limitative to the present invention.

### DESCRIPTION OF THE DRAWINGS

FIG. 1. Shows a particular schema of the procedure for performing the remineralization of the infusion of a system of inverse osmosis installed in a desalination plant wherein the addition of calcium hydroxide and CO₂ is performed linearly. In this way, the total amount of the water to be treated Qₜ is separated in flow Q₁ (1) and flow Q₂ (2). (3) represents the dosage in line of the reagents (4) lime milk prepared with part of Q₁ and (5) CO₂. (6) is the remineralization chamber, (7) is the filtration system, (8) represents the mixing point, (9) is a tank for storage of the filtrate, (10) represents the backwashings, (11) represents the chemical washings, (12) represents the discharge of the backwashing water and (14) represents its recirculation at the front of the installation. (15) represents the discharge of the water of the chemical washing and (16) represents its recirculation at the front of the installation. (13) represents the possible addition of acid or base for the fine tuning of pH after the mixing point (8). (17) represents the entry of the fluid without remineralization.

FIG. 2. Shows a schema of the procedure for performing the remineralization of the infusion of a system of inverse osmosis installed in a desalination plant wherein the addition of CO₂ is performed by means of an absorber followed by the addition of calcium in the form of lime milk. In this way, the total amount of the water to be treated Qₜ, is separated in flow Q₁ (1) and flow Q₂ (2). (3) represents an absorber totally flooded with a filling submerged prior to the dosage of the CO₂ (5). (4) represents the addition of the lime milk in a separating line prepared with a portion of Q1. (6) is the remineralization chamber, (7) is the filtration system, (8) represents the mixing point, (9) is a tank for storage of the filtrate, (10) represents the backwashings, (11) represents the chemical washings, (12) represents the discharge of the backwashing water and (14) represents its recirculation at the front of the installation. (15) represents the discharge of the water of the chemical washing and (16) represents its recirculation at the front of the installation. (13) represents the possible addition of acid or base for the fine tuning of pH after the mixing point (8). (17) represents the entry of the fluid without remineralization.

FIG. 3. Shows a schema of the procedure for performing the remineralization of the infusion of a system of inverse osmosis installed in a desalination plant wherein the addition of CO₂ is performed by means of an absorption column followed by the addition of Ca(OH)2 in the form of lime milk.

In this way, the total amount of the water to be treated Qₜ, is separated in flow Q₁ (1) and flow Q₂ (2). (3) represents an absorption column flooded with internal filling and a rain spray with dosage of the CO₂ (5). (4) Represents the addition of the lime milk in line prepared with a portion of Q1. In this case, Q₁ is divided in two quantities: one fraction for diluting the CO₂ and the other one for preparation of the lime milk (preparation with a fluid without remineralization). (6) is the remineralization chamber, (7) is the filtration system, (8) represents the mixing point, (9) is a tank for storage of the filtrate, (10) represents the backwashings, (11) represents the chemical washings, (12) represents the discharge of the backwashing water and (14) represents its recirculation at the front of the installation. (15) represents the discharge of the water of the chemical washing and (16) represents its recirculation at the front of the installation. (13) represents the possible addition of acid or base for the fine tuning of pH after the mixing point (8). (17) represents the entry of the fluid without remineralization.

FIG. 4. Shows a schema of the procedure for performing the remineralization of the infusion of a system of inverse osmosis wherein the addition of CO₂ is performed by means of an absorption column followed by the addition of CaCO₃ or MgCa(CO₃)₂ by means of granular lime milk and because of that the fluid percolates.

In this way, the total amount of the water to be treated Qₜ, is separated in flow Q₁ (1) and flow Q₂ (2). (3) represents an absorption column flooded with internal filling and a rain spray with dosage of the CO₂ (5). (4) represents the granular lime milk of CaCO₃ or MgCa(CO₃)₂. (6) is the remineralization chamber, (7) is the filtration system, (8) represents the mixing point, (9) is a tank for storage of the filtrate, (10) represents the backwashings, (11) represents the chemical washings, (12) represents the discharge of the backwashing water and (14) represents its recirculation at the front of the installation. (15) represents the discharge of the water of the chemical washing and (16) represents its recirculation at the front of the installation. (13) represents the possible addition of acid or base for the fine tuning of pH after the mixing point (8). (17) represents the entry of the fluid without remineralization.

### EXAMPLES

The present invention is illustrated additionally with the help of 3 preferred embodiment examples which do not limit in any way its scope.

### Example 1

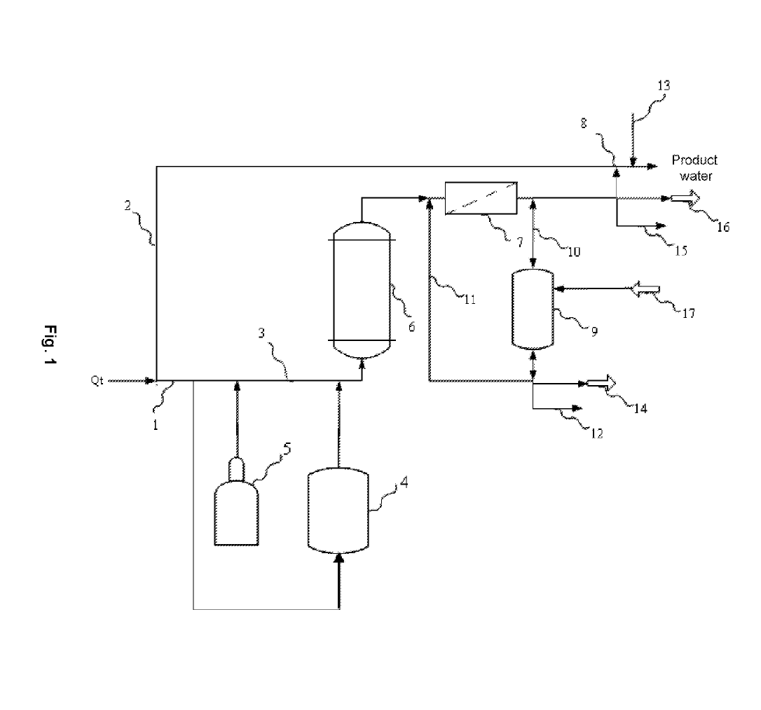

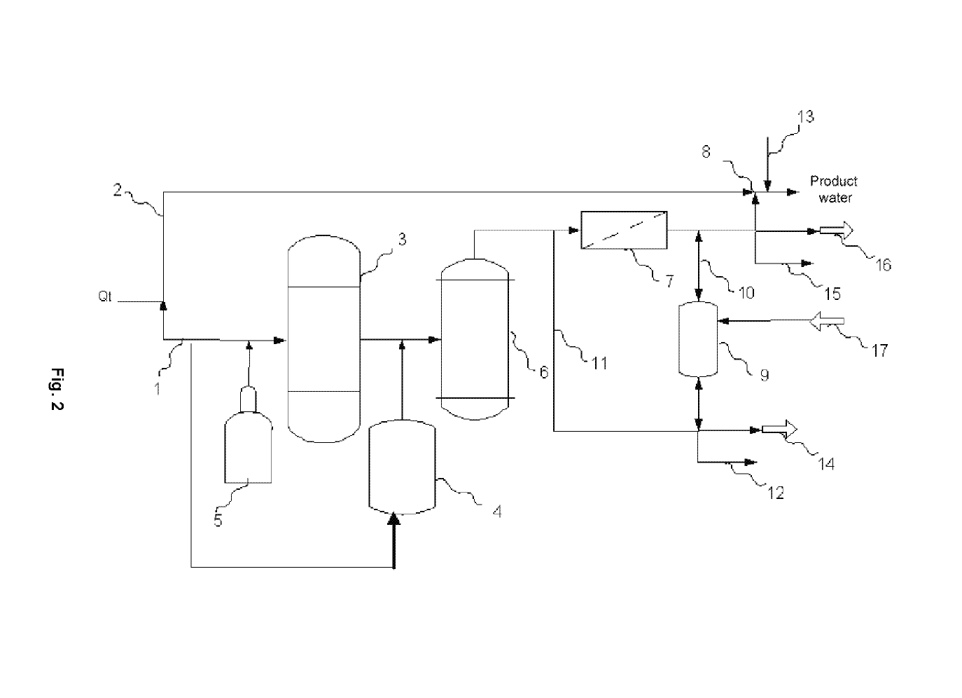

The configuration in FIG. 1 is used to remineralize the infusion of a system of inverse osmosis installed in a desalination installation with a concentration of 3.2 ppm of Ca²⁺ ions, LSI of −3.97, pH of 6.09 and turbidity of 0.09 NTU. The objectives of the remineralization are to obtain a concentration of Ca²⁺ greater than or equal to 35 ppm, turbidity less than 0.2 NTU and LSI between −0.5 and +0.5 in the product water.

The total flow of the water to be treated Qₜ (1.1 m³/h) is separated in two flows: The flow Q₁ (1), which represents 50% of Qₜ, and the flow Q₂ (2). To Q₁ (1) it is added in line (3) the CO₂ (5) and the calcium hydroxide (Ca(OH)₂) (4) in the form of lime milk (0.3%) prepared with part of the infusion of the reverse osmosis without preliminary passage through the saturator. Thus 2 and 220 ml/min are added respectively.

The obtained solution is introduced into a remineralization chamber (6) which provides a hydraulic residence time (THR) of 10 min.

Finally this solution is passed through a microfiltration system under pressure (7) with a hollow fiber (filtration from outside to inside) of PVDF and operation in dead-end with a flux of 80±10 lmh.

The backwashing of the filter (10) is performed every 30 minutes by using infusion water with air and without chemicals for 5 minutes with entry from (17). In addition, chemical washings (11) are performed with hydrochloric acid at pH 2 with a daily periodicity, as well as washings with sodium hypochlorite for disinfection, depending on the needs. At least one tank (9) is necessary for that.

After it has been subjected to filtration, the remineralized flow Q₁ (turbidity between 3 and 4 NTU) is mixed (8) with the flow Q₂ without remineralization and the total flow Qₜ is obtained with much reduced turbidity (≦0.2 NTU), pH about 8 and LSI between −0.5 and 0.5. The pH is adjusted after the mixing to the exact values by adding caustic soda (NaOH) (13).

### Example 2

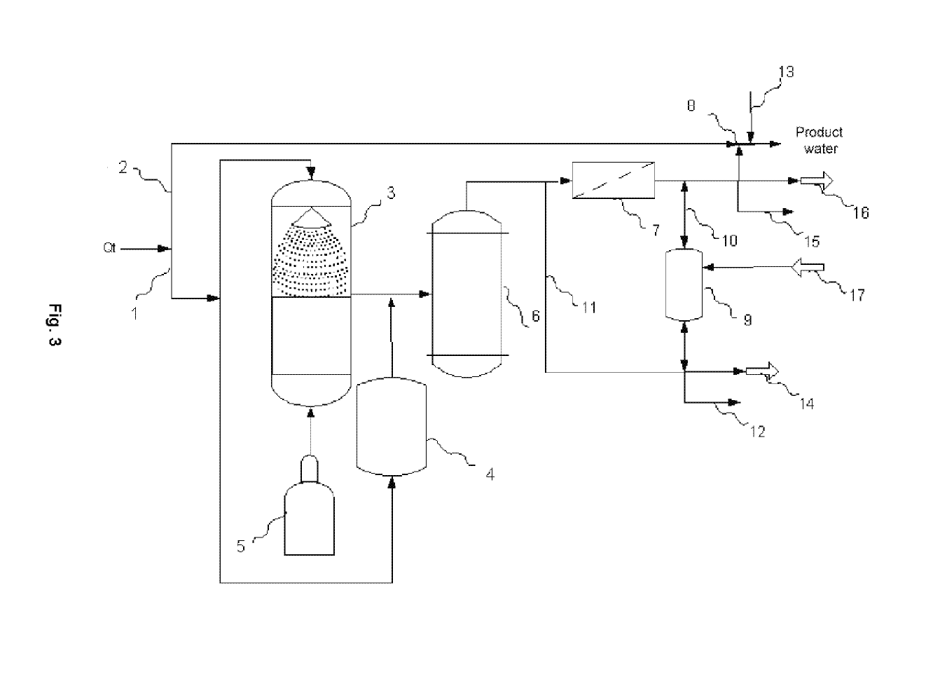

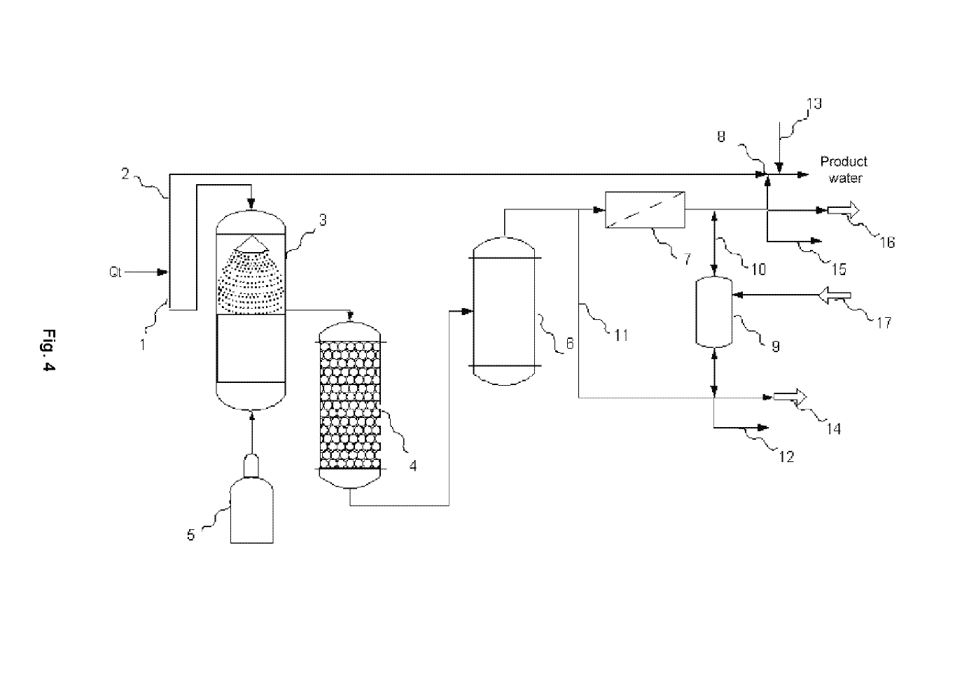

The configuration in FIG. 2 is used to remineralize the infusion of a system of inverse osmosis installed in a desalination installation with a concentration of 3.2 ppm of Ca²⁺ ions, LSI of −4.06, pH of 5.95 and turbidity of 0.08 NTU. The objectives of the remineralization are to obtain a concentration of Ca²⁺ greater than or equal to 35 ppm, turbidity less than 0.2 NTU and LSI between −0.5 and +0.5 in the product water.

The total flow of the water to be treated Qₜ (2.75 m³/h) is separated in two quantities: The flow Q₁ (1), which represents 20% of Qₜ, and the flow Q₂ (2). CO₂ (5) is added to Q₁ (1) at the amount of 5 l/min in an absorber completely flooded with internal filling (3). Then calcium hydroxide (4) (Ca(OH)₂) is added in the form of lime milk (0.3%) prepared with part of the infusion of a system of inverse osmosis without a preliminary passage through the saturator, at the amount of 550 ml/min.

Then the mixture passes through the remineralization chamber with a hydraulic residence time of 5 minutes.

Finally this solution is passed through a microfiltration system under pressure (7) with a hollow fiber (filtration from outside to inside) of PVDF and operation in dead-end with a flux of 80±10 lmh.

The backwashing of the filter is performed every 60 minutes by using infusion water with air and without chemicals for 5 minutes with entry from (17). In addition, chemical washings are performed with hydrochloric acid (HCl) at pH 2 with a daily periodicity, as well as washings with sodium hypochlorite for disinfection, depending on the needs.

After it is subjected to filtration, the remineralized flow Q₁ (turbidity between 40 and 60 NTU) is mixed (8) with the flow Q₂ without remineralization, and the total flow Qₜ is obtained with a significantly reduced turbidity (≦0.2 NTU), pH around 8 and LSI between −0.5 y 0.5.

After the mixing, the pH is adjusted by adding caustic soda (NaOH) (13) until the exact values are reached.

### Example 3

The configuration in FIG. 2 is used to remineralize the infusion of a system of inverse osmosis installed in a desalination installation with a hardness of 8.33 ppm expressed as calcium carbonate (CaCO₃), by fixing as objectives of the remineralization to obtain calcium-related hardness in the product water greater than or equal to 71 ppm CaCO₃, turbidity lower than 0.2 NTU and LSI between −0.5 and +0.5 in the product water.

The total flow of the water to be treated Qₜ (4000 m³/h) is separated in two quantities: The flow Q₁ (1) (70 m³/h), which represents 1.75% of Qₜ, and the flow Q₂ (2). 20 m³/h of the Q₁ (1) are diverted for the preparation of the lime milk, while the remaining 50 m³/h are introduced in an absorption column, which is partially flooded with internal filling (3) by means of a rain spray. In this way, the water falls on the lime milk filling in the form of a rain, where it enters in contact with the CO₂ (5) which is bubbled from the bottom at the amount of 201 m³/h.

For the preparation of the lime milk (4), 140 kg/h of calcium hydroxide CaO are added to the 20 m³/h diverted from the Q₁, thus obtaining 1% lime milk. This lime milk is added to the mixture coming out of the absorption column (3).

Then the mixture passes through the remineralization chamber with a hydraulic residence time of 5 minutes.

Finally, this solution passes through a wire mesh filter (out-in filtration) and a dead-end operation.

The backwashing of the filter is performed every 30 minutes with infusion water with entry from (17).

After it has been subjected to filtration, the remineralized flow Q₁ is mixed with the flow Q₂ without remineralization, and the total flow Qₜ is obtained with average turbidity of 0.1 NTU and lower than 0.2 NTU at any moment. The LSI is between −0.5 and +0.5, the pH is around 8, and hardness greater than 71 ppm calcium carbonate (CaCO₃) is obtained.

After the mixing, the pH is adjusted by adding caustic soda (NaOH) (13) until the exact values are reached.

1-41. (canceled)

42. A procedure for remineralisation of water, which comprises the following steps:
a. Divide an initial flow Qₜ of the fluid into 2 flows Q₁ and Q₂; wherein the flow Q₁ is between 0.5% to 99.5% with respect to Qₜ and the flow Q₂ is between 99.5% to 0.5% with respect to Qₜ;
b. Dose reagents to the flow Q₁ from step a); wherein the flow Q₁ is introduced into a reactor during a hydraulic residence time less than or equal to 120 minutes;
c. Filter the flow Q₁ from step b);
d. Mix the flow Q₁ from step c) with the flow Q₂ from step a); and
e. Adjust of the pH of the flow mix of step d) by adding acid or base.

43. The procedure according to claim 42, wherein the flow Q₁ is between 0.5% and 25% with respect to Qₜ.

44. The procedure according to claim 42, wherein the flow Q₂ is between 99.5% and 75% with respect to Qₜ.

45. The procedure according to claim 42, wherein the reagent of step b) is selected from the group formed by CaCO₃, MgCa(CO₃)₂, Ca(OH)₂, CaO, and MgO, in combination with CO₂ and in combination or not with an acid.

46. The procedure according to claim 45, wherein the reagent of step b) is Ca(OH)₂.

47. The procedure according to claim 46, wherein the Ca(OH)₂ is dosed as lime milk with or without a preliminary passage through a saturator.

48. The procedure according to claim 47, wherein the lime milk is prepared by means of preparing a suspension of Ca(OH)₂ in water or by means of reacting CaO with water.

49. The procedure according to claim 45, wherein the dosage of the CO₂ is performed:
in a mixing chamber and bubbling CO₂ for reaction with the reagents of step b); or
bubbling CO₂ in a completely flooded absorber, with or without internal filling; or
bubbling CO₂ in an absorption column partially flooded with a rain spray, or with a sprayer, with or without internal filling.

50. The procedure according to claim 49, wherein the excess of CO₂ not reacted with the reagents of step b), is recirculated into the dosing system of step b).

51. The procedure according to claim 42, wherein the hydraulic residence time of step b) is less than or equal to 30 minutes.

52. The procedure according to claim 42, wherein the filtration system of step c) is selected from the group formed by metal filters, cartridge filters, through micro-filtration, through ultra-filtration and any combination of them.

53. The procedure according to claim 52, wherein the filtration system of step c) is micro-filtration system under pressure.

54. The procedure according to claim 53, wherein the micro-filtration under pressure is performed in cross-flow or dead-end.

55. The procedure according to claim 42, wherein a step c,) for backwashing of the filtration system of step c) is performed.

56. The procedure according to claim 55, wherein the backwashing of step cᵢ) is performed with water, with or without air and with or without chemical agents, or with a fluid without remineralisation.

57. The procedure according to claim 56, wherein the fluid without remineralisation comes from inverse osmosis system with or without air and with or without chemical agents.

58. The procedure according to claim 55, wherein after step cᵢ) of backwashing, a step cᵢᵢ) of chemical washing of the filtration system is performed.

59. The procedure according to claim 58, wherein the chemical washing is performed with water with chemical agents with or without air or with a fluid with chemical agents without remineralisation.

60. The procedure according to claim 59, wherein the fluid without remineralisation comes from inverse osmosis system with or without air and with or without chemical agents.

61. The procedure according to claim 42, wherein the chemical agents of step e) are selected among the HCl, H₂SO₄, citric acid, ascorbic acid, NaOH and NaOCl.

62. The flow obtained in step e) can be recirculated and used as initial flow Qₜ, according to claim 42.
